(19) United States
(12) Patent Application Publication
(10) Pub. No.: US 2026/0106562 A1
(43) Pub. Date: Apr. 16, 2026

(54) METHOD FOR PREVENTING DEMAGNETIZATION OF MAGNETS IN AN ELECTRIC MACHINE

(71) Applicant: MAGNA Powertrain GmbH & Co KG, Lannach (AT)

(72) Inventor: Claudio Ricca, Wien (AT)

(21) Appl. No.: 19/351,489

(22) Filed: Oct. 7, 2025

(30) Foreign Application Priority Data
Oct. 11, 2024 (DE) 10 2024 129 475.2

(51) Int. Cl. H02P 23/00

(52) U.S. Cl. CPC H02P 23/00

(57) ABSTRACT

A method for preventing demagnetization during the operation of an electric machine with a stator and rotor, in which one or a plurality of permanent magnets are used, includes field-oriented control of an inverter with a control unit. The control unit has a computed table of a motor grid including a plurality of load points on a plane, having different values for current and phase angle and the ascertained torque of the electric machine, and for determining the maximum torque per ampere (MTPA) corresponding to the maximal available voltage for each of the load points, and for determining the absolute value of the coercive field strength (bHc) within the magnets for each load point.

### CROSS-REFERENCE TO RELATED APPLICATIONS

This application claims priority to DE 10 2024 129 475.2 filed Oct. 11, 2024. The entire disclosure of the above application is incorporated herein by reference.

### FIELD

The present disclosure relates to a method for preventing demagnetization during the operation of an electric machine with a stator and a rotor, in which one or a plurality of permanent magnets are used, and field-oriented control of an inverter with a control unit.

### BACKGROUND

This section provides information related to the present disclosure which is not necessarily prior art.

There has been a sharp increase in the use of purely electric vehicles and hybrid vehicles such as, for instance, battery-powered electric vehicles, electric vehicles with range extenders, hybrid electric vehicles, plug-in hybrid electric vehicles and fuel-cell hybrid electric vehicles in the last few years.

The propulsion for the hybrid electric vehicles and for other transport devices provided with electric power can be provided by electric motors. Many electric motors contain permanent magnets which can demagnetize, which compromises the performance of the electric motor.

The demagnetization may be a consequence of various reasons such as, for instance, temperature, age and/or specific events. In many transport devices provided with electric power it is a challenge to minimize demagnetization while continuing to meet torque requirements.

A further objective lies in developing and producing cost-effective drivetrains with minimal CO2 emissions in order to reduce environmental damage and to promote eco-friendliness.

To this end, raw materials that are available in relatively large quantities and comparatively more widely around the world are being used in order to reduce dependence on individual countries and monopolies.

To address these goals, original equipment manufacturers are making great efforts to reduce the content of heavy rare earth metals in their motors.

Heavy rare earth metals are decisive because they increase the intrinsic coercive field strength Hcj. However, the mining of rare earth metals such as dysprosium and terbium is very energy-intensive and environmentally damaging. Therefore, it is becoming increasingly desirable to dispense with these elements.

In magnets, a distinction is made between the coercive field strength bHc of flux density and the coercive field strength jHc of polarization. When a magnet is exposed to a demagnetizing field strength of bHc, the magnetic flux density in the magnet vanishes. The magnet per se is still magnetic, but the flux density generated by it is identical and counter to the flux density of the demagnetized field, such that the two cancel one another out. The magnet completely loses the magnetic polarization and thus its own magnetization only at a high demagnetizing field strength, i.e. when the demagnetizing field strength is above a threshold of the bH curve.

A high jHc value means that a magnet is more resistant to opposing currents and unfavourable conditions that could cause irreversible demagnetization.

The development and production of motors that resist irreversible demagnetization without the use of rare earth metals continues to represent a great challenge.

DE 10 2022 126 157 A1 discloses a method for minimizing demagnetization, in which one or a plurality of permanent magnets are used; wherein the controller is conceived to: determine a demagnetization line which represents a q-axis threshold stator current, partially based on at least one variable motor parameter; selecting a starting point on a stator current trajectory, which is defined by a d-axis stator current command and by a q-axis stator current command, wherein the starting point intersects a voltage threshold ellipse representing a predefined voltage threshold, a global current threshold and a curve of the desired torque; obtaining an intermediate point on the stator current trajectory by moving from the starting point along a curve of the desired torque until the demagnetization line is reached; selecting the intermediate point as an end point on the stator current trajectory if the intermediate point is at or within the predefined voltage threshold; determining the end point on the stator current trajectory by moving from the intermediate point along the demagnetization line until the predefined voltage threshold is met if the intermediate point is outside the predefined voltage threshold; and generating a demagnetized torque capability based on the end point on the stator current trajectory.

### SUMMARY

This section provides a general summary of the disclosure, and is not a comprehensive disclosure of its full scope or all of its features.

It is an object of the present disclosure to propose an optimized method for the avoidance of demagnetization. The method according to the present disclosure has the objective of maximizing the torque of a permanent magnet motor with magnets with a low jHc, without causing irreversible demagnetization.

The object is achieved by a method for preventing demagnetization during the operation of an electric machine with a stator and rotor, in which one or a plurality of permanent magnets are used, and a field-oriented control of an inverter with a control unit; wherein the control unit has a computed table of the motor grid including a plurality of load points on a plane, having different values for current and phase angle and the ascertained torque of the electric machine, and for determining the maximum torque per ampere corresponding to the maximum available voltage for each of the load points, and for measuring the absolute value of the coercive field strength within the magnets for each load point.

These points are ascertained using a precise and effective method which is based on simulations using finite elements. The simulations have the objective of measuring the field strength of the magnets over the entire magnetic range at each load point, to verify the degrees of demagnetization, and to select only those operating points that do not demagnetize the machine.

The method does not depend on how the magnets are fixed in the core, or how the laminated rotor cores or the rotor core are produced.

The method does not depend on how the calculations of the demagnetization ratios are carried out.

In an advantageous refinement, the calculation of a demagnetization ratio DR=(magnet surface irreversibly demagnetized/overall magnet surface)*100 starts at a maximum value of H, once the irreversible demagnetization sets in.

The method restricts the field-oriented control to the range of the still acceptable points of demagnetization.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows an example of a rotor segment,

FIG. 2 shows an example of the motor load points that extend over the entire operating range and are used to trigger the strategy for the demagnetization control,

FIG. 3 shows the permissible operating ranges in which the motor can operate without demagnetization.

FIG. 4 shows another permissible operating ranges in which the motor can operate without demagnetization.

### DETAILED DESCRIPTION

A control strategy for electric machines in the automotive industry is controlling to a maximum torque per ampere MTPA. This closed-loop control strategy has the objective of maximizing the torque by way of the lesser amount of current and thus of the lesser amount of heat losses.

However, this modern control strategy cannot be implemented when the jHc value of the magnets is low, because this control may lead to an irreversible demagnetization of the motor magnets. Values which are in the range of 350 kA/m or below are understood to be low jHc values.

When the coercive field strength jHc of the magnets is low, a special control strategy, which is presently referred to as maximum torque per demagnetization MTPD, must be implemented. This control strategy prevents the demagnetization of the magnets and enables the maximum torque of the machine to be preserved.

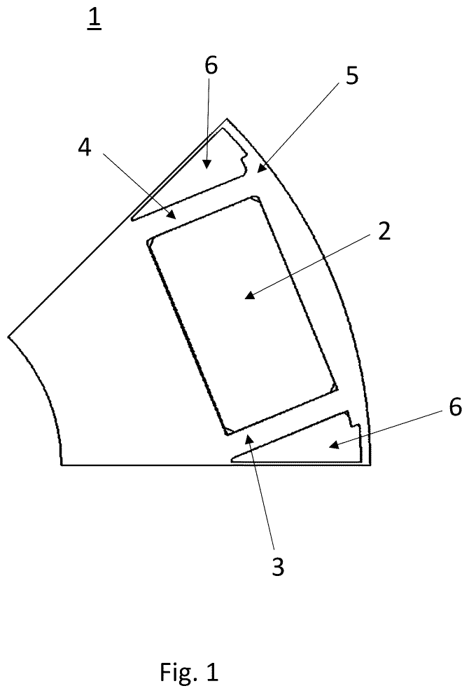

For the purpose of simplification and easier explanation of how this control strategy can be implemented, the rotor topology illustrated in FIG. 1 will be used for this case study.

FIG. 1 represents a rotor which is constructed from individual rotor segments 1. A rotor segment 1 has a clearance for receiving a magnet 2. This magnet 2 is supported by a first radial support rib 3 and a second radial support rib 4. Furthermore, the magnet is externally bordered by a tangential support rib 5.

Pockets 6 which serve to dissipate mechanical loads are also provided in the laminated rotor core of the rotor segment 1.

The method is independent of the rotor topology and can be used for any permanent magnet topology.

The rotor of a permanent magnet motor generates its own magnetic field with the aid of magnets that are either attached to its surface or are embedded in said rotor. When an alternating current AC is applied to the stator windings, it generates a rotating magnetic field. This rotating field interacts with the magnetic field of the rotor and has the effect that the rotor follows the movement of the stator.

In the field-oriented control FOC, the stator current is illustrated in polar coordinates and has two components:
the direct current Id, which is aligned with the magnetic field of the rotor; and
the current in the quadrature axis Iq, which runs perpendicularly to the magnetic field of the rotor.

The electric angle (θ), also referred to as the load angle, represents the angle between the stator current and the magnetic field of the rotor. This angle controls the alignment between the magnetic stator field and the magnetic rotor field and has an effect on torque generation.

For example, in a surface-mounted permanent magnet motor SMPM, the quadrature current Iq is responsible for generating the torque, similar to how the armature current generates the torque in a DC motor. In order to maximize the torque, the stator current is set in such a way that it flows completely in the quadrature direction Iq, while the direct current Id is kept to zero. It is thus ensured that the entire current is used for generating the torque and not for magnetization.

The field-oriented control FOC is carried out by inverters in order to represent the management of multi-phase motors. This closed-loop control is achieved by applying a DC closed-loop control model at the input, which simplifies the complex AC commutating output. This approach enables the closed-loop proportional-integral control circuit of the inverter to effectively feedback-control selective DC variables which are not temporally variable, and to treat the AC motor like a DC motor. In a wound DC motor, which includes a stator winding, which is responsible for the magnetization of the flux, and of an armature winding for generating the torque, the FOC influences the modelled winding currents in order to control torque and rotating speed.

The control method begins in the same way as other control methods in step 1 by calculating a motor/generator circuit. For this purpose, a plurality of points on a plane, having different values for current and phase angle, are simulated in order to ascertain the torque of the machine.

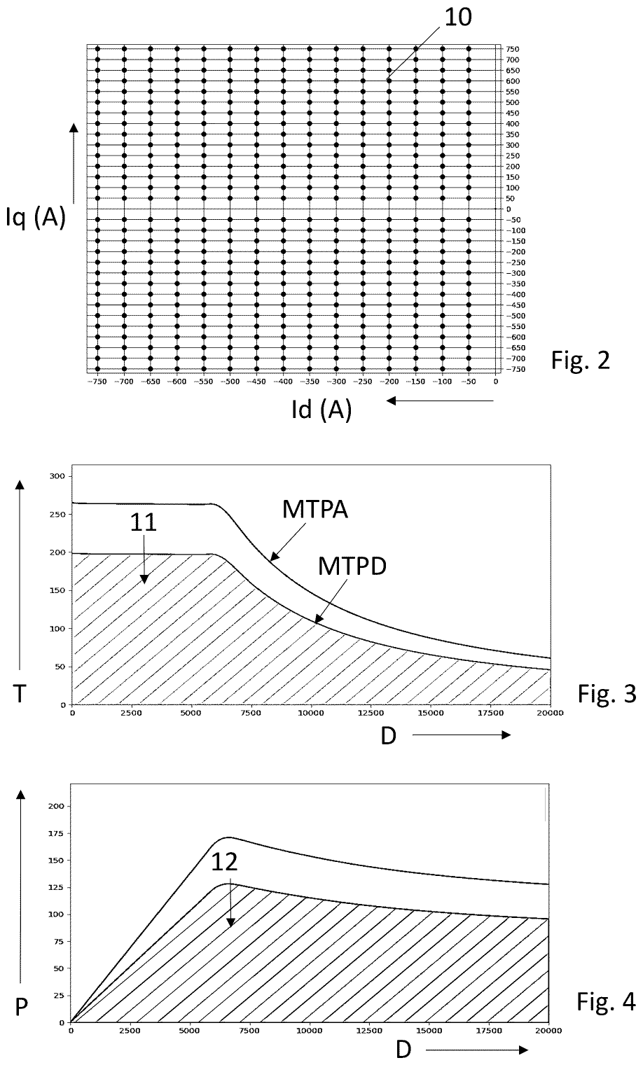

Such an example of a motor grid with the load points to be simulated in a finite element analysis FEA is illustrated on an Id-Iq plane in FIG. 2.

Upon calculating the motor grid, the usual method includes triggering the values of the torques for each load point 10, and determining the maximum torque per ampere MTPA, which corresponds to the maximum torque that the machine can deliver at the maximum available voltage.

At this point, an additional limitation, provided by the demagnetization of the magnets, has to be inserted.

The method is a surface-based approach and includes measuring the absolute value of the coercive field strength bHc within the magnets for each load point.

For this purpose, a transient simulation with a specific number of temporal steps is carried out for each load point, and the values for bHc in the magnets are measured in each temporal step, wherein the temporal step with the poorer demagnetization conditions serves as a reference.

For each of the load points 10, the surface elements which are associated with the magnets and have a higher field strength than the field strength corresponding to the knee of the magnet bH curve are considered to be irreversibly demagnetized.

The following coefficient can then be determined for each load point 10:

$$demagnetization coefficient DR = {( irreversibly demagnetized magnet surface / overall magnet surface )}^{*} 100.$$

The demagnetization ratio DR indicates the percentage of the magnet surface that is irreversibly demagnetized at a specific load point.

Since the demagnetization ratio DR is now defined and available for each load point of the machine, the method for verifying the demagnetization can be applied.

The method takes into account the load points 10 in terms of the current and phase advance, which maximize torque but do not demagnetize the magnets, specifically precisely those points whose demagnetization ratio DS is below a specific threshold considered acceptable.

In principle, no demagnetization of the magnet is accepted, but minute points which are for example demagnetized on the corner of the magnet cannot be avoided. For this reason, an appropriate demagnetization ratio DS value can be 0.5%.

In FIGS. 3 and 4, the maximum torque and the maximum output which are achieved by the presently developed demagnetization verification strategy called “maximum torque per demagnetization” MTPD are compared with the verification strategy “maximum torque per ampere” MTPA of the exemplary machine from FIG. 1.

In FIG. 3, the torque T is plotted over the rotating speed D. The points 11 indicate the demagnetization caused by torque, wherein the points below the curve MTPD are within the acceptable range of 0.5%.

In FIG. 4, the output P is plotted over the rotating speed D. The points 12 indicate the demagnetization caused by output, wherein the points below the curve MTPD are within the acceptable range of 0.5%.

As can be seen, the maximum torque per ampere MTPA of the upper curves cannot be used in this case, because it would irreversibly demagnetize the magnets. The maximum torque per demagnetization MTPD, the stepped curve, is the control strategy for maximizing the torque and preventing irreversible demagnetization.

What is claimed is:

1. A method for preventing demagnetization during the operation of an electric machine with a stator and rotor, in which one or a plurality of permanent magnets are used, the method comprising:
performing field-oriented control of an inverter with a control unit,
wherein the control unit has a computed table of a motor grid having a plurality of load points on a plane, having different values for current and phase angle;
ascertaining torque values for each of the load points of the electric machine, and
determining, for each of the load points, a maximum torque per ampere (MTPA), corresponding to a maximum torque that the electric machine can deliver at the maximum available voltage, and
determining, for each load point, an absolute value of the coercive field strength (bHc) within the magnets.

2. The method for preventing demagnetization according to claim 1, wherein the torque values at each of the load points are ascertained based on simulations using finite elements.

3. The method for preventing demagnetization according to claim 2, wherein, using the simulations, the coercive field strength (bHc) of the magnets at each load point is determined over an entire magnetic range in order to verify degrees of demagnetization, and only those operating points that do not demagnetize the magnets of the electric machine are selected as acceptable, wherein acceptable points are defined by those points where a demagnetization ratio is below a threshold level.

4. The method according to claim 3, wherein the demagnetization ratio DR=(magnet surface irreversibly demagnetized/overall magnet surface)*100 is determined for each load point.

5. The method according to claim 4, wherein the field-oriented control is restricted to a range of acceptable points of demagnetization.

6. The method according to claim 1, wherein determining the absolute value of the coercive field strength includes a transient simulation with a specific number of temporal steps carried out for each load point, and the values for bHc in the magnets are measured in each temporal step, wherein the temporal step with the poorer demagnetization conditions serves as a reference.

7. The method according to claim 1, wherein, for each load point, surface elements associated with the magnets and having a higher field strength that the field strength corresponding to a bend in the bH curve are determined to be irreversibly damaged.

8. The method according to claim 5, wherein the demagnetization ratio indicates a percentage of the magnet surface that is irreversibly damaged at a specific load point.

9. The method according to claim 8, wherein each load point whose demagnetization ratio is below a specific threshold is considered acceptable.

10. The method according to claim 9, wherein a maximum torque per demagnetization (MTPD) curve is determined based on the acceptable load points, wherein the MTPD curve is defined by points that are less than the MTPA curve, wherein points below the MTPD curve are acceptable.

11. The method according to claim 10, wherein the MTPD curve is based on torque (T) plotted over a rotating speed (D), wherein the curve is defined by points where demagnetization is caused by torque.

12. The method according to claim 10, wherein the MTPD curve is based on output (P) plotted over a rotating speed (D), wherein the curve is defined by points where demagnetization is caused by output.

13. The method according to claim 1, wherein the different values for current and phase angle for the load points include values for direct current Id, which is aligned with a magnetic field of the rotor, plotted against values for current Iq in a quadrature axis, which runs perpendicular to the magnetic field of the rotor.

14. The method according to claim 1, wherein operation of the electric motor to provide torque is restricted to load points where it is determined that the amount of demagnetization is below a threshold level.
